(19) United States
(12) Patent Application Publication
(10) Pub. No.: US 2011/0156956 A1
(43) Pub. Date: Jun. 30, 2011

(54) Subreflector Tracking Method, Apparatus and System for Reflector Antenna

(75) Inventor: Douglas Alan Gribben, Plano, TX (US)

(73) Assignee: ASC SIGNAL CORPORATION, Smithfield, NC (US)

(21) Appl. No.: 13/060,940

(22) PCT Filed: Dec. 17, 2009
(86) PCT No.: PCT/US09/68589

§ 371 Date: Feb. 25, 2011

Related U.S. Application Data
(60) Provisional application No. 61/138,148, filed on Dec. 17, 2008.

(51) Int. Cl. G01S 1/00; H01Q 19/18

(52) U.S. Cl. 342/385; 343/761; 343/760

(57) ABSTRACT

A subreflector tracking method, apparatus and system incorporating sensor feedback of the precise subreflector angular position of a nutating subreflector. The subreflector nutation generated by coupling the subreflector, off center, to a rotating support. Monitoring of the received signal strength peak during a rotation of the subreflector generating an error vector designating a direction in which to move the subreflector to track the signal.

### BACKGROUND

Earth station to satellite communication systems require a tracking system that maintains a precision Earth station antenna orientation with the target satellite. For large antennas to track satellites with non-trivial astrodynamics, for example operating in the Ka band, fine movement control is required. Tracking systems that orient the entire antenna assembly with a high level of precision, including main reflectors that may be of significant dimensions, may be cost prohibitive.

Commonly owned U.S. Pat. No. 6,943,750, “Self-Pointing Antenna Scanning” issued Sep. 13, 2005 to Brooker et al, hereby incorporated in its entirety by reference, discloses a motorized subreflector with orthogonal adjustment capability via x and y axis drive screws to move the subreflector with respect to the main reflector to achieve a limited range of antenna beam orientation, separate from manipulation of the primary antenna mount supporting the entire antenna assembly. Feedback loops incorporating the received signal characteristics may be used to enable precision tracking. However, the tracking accuracy is limited by the time requirements for the drive screws to move forward and back, driving the subreflector past an optimal orientation to obtain a signal peak indication.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with the general and detailed descriptions of the invention appearing herein, serve to explain the principles of the invention.

FIG. 1 is a schematic front view of an exemplary subreflector assembly.

FIG. 2 is a schematic system diagram of an exemplary motorized subreflector control system, carriage removed for clarity.

FIG. 3 is a close up schematic diagram of the subreflector rotation sensor/target arrangement of FIG. 2.

FIG. 4 is a schematic diagram of an exemplary motorized subreflector processing system.

### DETAILED DESCRIPTION

The inventor has recognized that a subreflector tracking system incorporating sensor feedback of the precise subreflector position may be obtained by combining conical-scan subreflector tracking with predictive or adaptive main reflector tracking to allow a Ka-band antenna system to track a non-geostationary satellite without a true monopulse receiver tracking system and corresponding high-accuracy main reflector positioner hardware.

One skilled in the art will recognize that the subreflector tracking system and method(s) disclosed herein, in addition to tracking variances from geosynchronous satellite orbits with high precision may also be used to track a wide range of satellite orbits, for example inclined orbit geosynchronous satellites and/or lower altitude orbits.

A typical satellite communications earth station antenna system for use with the invention includes:
Cassegrain or Gregorian dual-reflecting main reflector.
A motorized main reflector mount, designed either as a conventional Az/El mount or as a polar mount.
A motorized subreflector carriage capable of X-Y displacement from the nominal boresight. The limits of this travel are restricted to avoid distortion of the received or transmitted signal.

These elements are well known in the art, and as such are not described with greater detail herein.

A nutating movement capability is added to the subreflector to generate a conical scan, for example by a spinning turntable or shaft upon which the subreflector is mounted, slightly off center. Thus, as the subreflector rotates, a nutation/conical scan is generated with a magnitude proportional to the offset distance between the center of the subreflector and the axis of rotation.

A sensor array such as a resolver, synchro, Hall effect or the like operative as position sensor(s) are provided to sense the current angular position of the subreflector with a high level of precision and a sample frequency corresponding at least to the subreflector speed of rotation. An angle and velocity estimator module receives the position sensor inputs and outputs an estimated current angle and sync pulse, such as a position sensor reporting top dead center of the subreflector. The angle and velocity estimator may also receive rotation control commands from a supervisory module and also output speed control feedback to a motor speed control driving the motor rotating the subreflector. The angle and velocity module estimator and motor speed control may be remote mounted proximate the subreflector, with a data network connection, for example via Ethernet or optical fiber to the supervisory module.

A satellite signal receiver system capable of determining the instantaneous strength of a reference signal such as a continuous wave RF beacon is coupled to the reflector antenna, detecting signal strength variances as the subreflector rotates through the conical scan.

An antenna control system capable of measuring or estimating the instantaneous angle of rotation of the nutating subreflector and digitally processing the received signal strength from the receiver system over, for example, each rotation of the nutating subreflector to produce an error vector for driving the antenna to peak on the reference signal.

A tracking algorithm designates the angle of rotation from each revolution where the peak signal is detected as the error vector and converts this error vector, for example, to x and y axis drive commands for the positioner motors, for example drive screws and/or gear or belt driven slides or the like to move the sub reflector carriage towards the peak signal location. Further, where the range of signal beam movement obtainable by subreflector tracking is approached, the tracking algorithm may output lower resolution drive instructions to the antenna main mount and drive the subreflector into the other end of its drive range, in anticipation of the main mount displacement.

The tracking algorithm may be selected from a range of different tracking algorithms according to the drive resolution, processing power available and the expected type of target satellite orbit and/or orbital distortions.

A first tracking algorithm is general predictive pointing with empirical optimization. This is accomplished as follows:

The main reflector may be driven continuously typically using predictions based on furnished Keplerian orbital elements and well-known astrodynamic calculations to produce a local look angle (either az/el or hour-angle/declination). This will allow the system to approximately track the satellite; however, path distortions such as refraction and scintillation, mechanical distortions in the antenna, and small errors in the Keplerian elements may produce a significant error in the tracking that is difficult to correct without feedback.

To correct these errors, the subreflector may be independently allowed to “float” to a continuously determined peak by using the error vector from the nutating subreflector (or using other techniques using only az and er displacement and parabolic curve fitting, for example as described in U.S. Pat. No. 6,657,588, “Satellite Tracking System Using Orbital Tracking Techniques” issued Dec. 2, 2003 to Strickland et al, hereby incorporated by reference in its entirety) processing system to actuate the X-Y carriage. When the signal is peaked, the conical scan produced by the nutating subreflector will center on the peak signal. As long as the tracking error of the main reflector is less than the range of the subreflector tracking systems, the system can track with only the additional cost of the small loss caused by the nutating subreflector's offset.

As the nutating subreflector floats, if an offset from center is persistent, the main reflector can be offset as well to center the subreflector, or to advance or retard the timing of the orbital track.

A second possible tracking algorithm is completely empirical pointing, accomplished as follows:

The main reflector is not initially driven continuously using predictions but rather to react to measured movement detected by the subreflector. As the nutating subreflector floats, the angular velocity of the target can be measured, and the control system directed to drive the main reflector at a continuous rate that matches this angle, and the floating nutating subreflector again optimizes the look angle. If a persistent bias is determined in the look angle, again, the main reflector look angle can be offset, or the rates changed, to adjust the timing of the orbital track. It is also possible to use a path planner to split movements between the main reflector and the subreflector movements.

In any case, as long as the sub-reflector is kept on the peak and within its limits of travel the system can track the satellite even if the main reflector's control system introduces errors larger than the half-power beamwidth of the antenna. The result is a significantly less expensive main beam mount (due to the complete elimination of the need for, for example, sub-10-arc-minute tolerances in positioning) and the elimination of the need for a complex receiver subsystem.

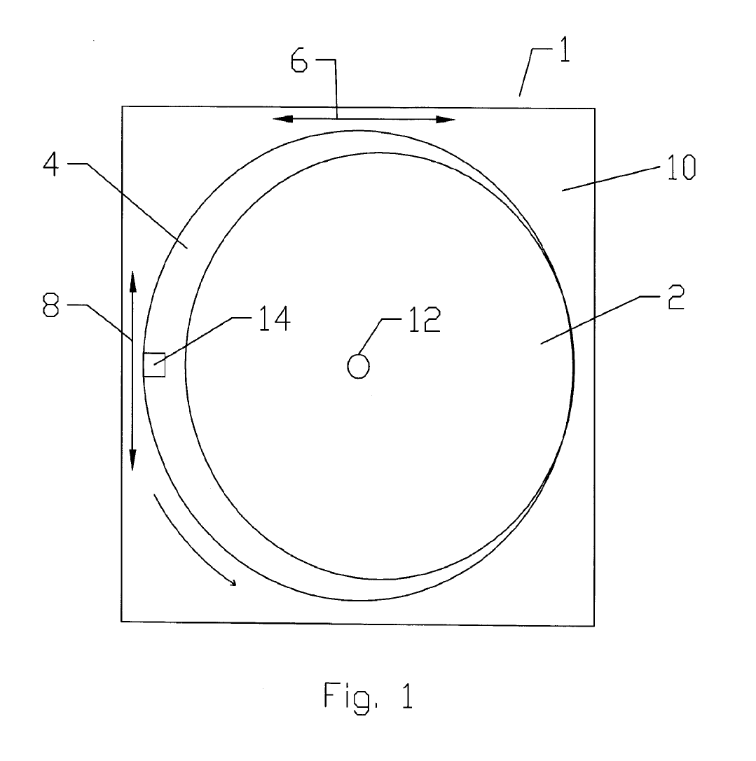

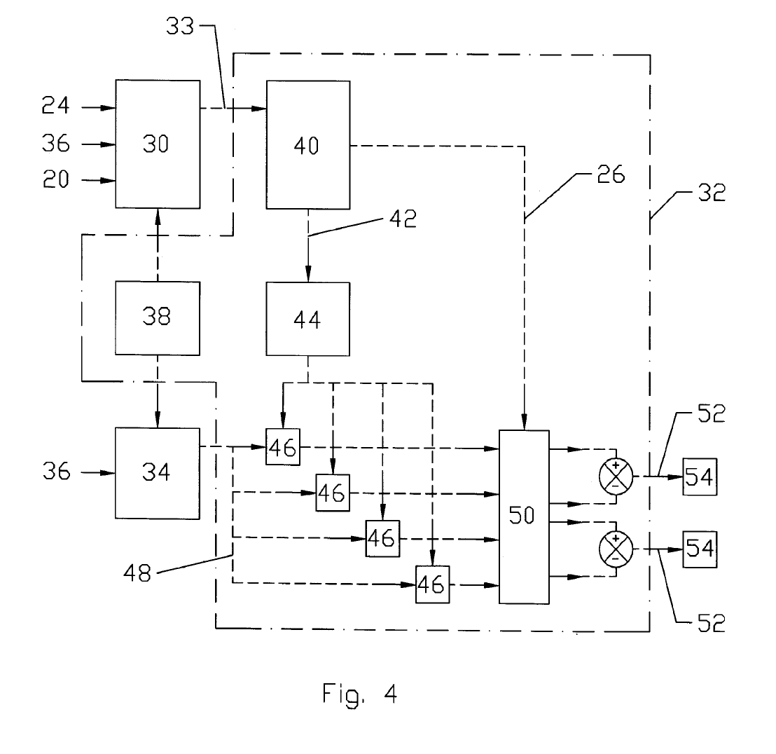

An exemplary subreflector 2 with a nutation mechanical arrangement 1 may be implemented, for example as shown in FIG. 1. The subreflector is offset slightly on its mounting on the turntable, which is in turn mounted on an X-axis 6 and Y-axis 8 moving carriage 10 that is fixed to a support arrangement of the reflector antenna (not shown) such as struts or a boom arm that positions the mechanical arrangement 1 and supported thereby subreflector 2 proximate the focal point of the reflector of the reflector antenna. The moving carriage 10 may be provided with a range of motion, for example up to 4 half power beamwidths actuated for example by positioner motors or the like (not shown). Rotation of the turntable 4 via rotation of the motor shaft 11 along the motor shaft longitudinal axis 13 creates a circular scanning effect that allows the control system (FIG. 4) to measure the pointing error and adjust for it using conical scan techniques. A small circle of rotation 12 (not shown in scale) for the subreflector 2, around which the sub reflector 2 rotates, may be configured in view of the subreflector 2 diameter and the offset from the center of rotation where the sub reflector 2 is mounted on the rotating shaft or turntable 4 surface. A counter weight 14 may be applied to account for an imbalance created by the offset mounting of the subreflector 2. The drive mechanism for the shaft or turntable may be configured as variable speed, for example with a speed range between zero to 120 rpm or more depending upon the dynamics of the desired target.

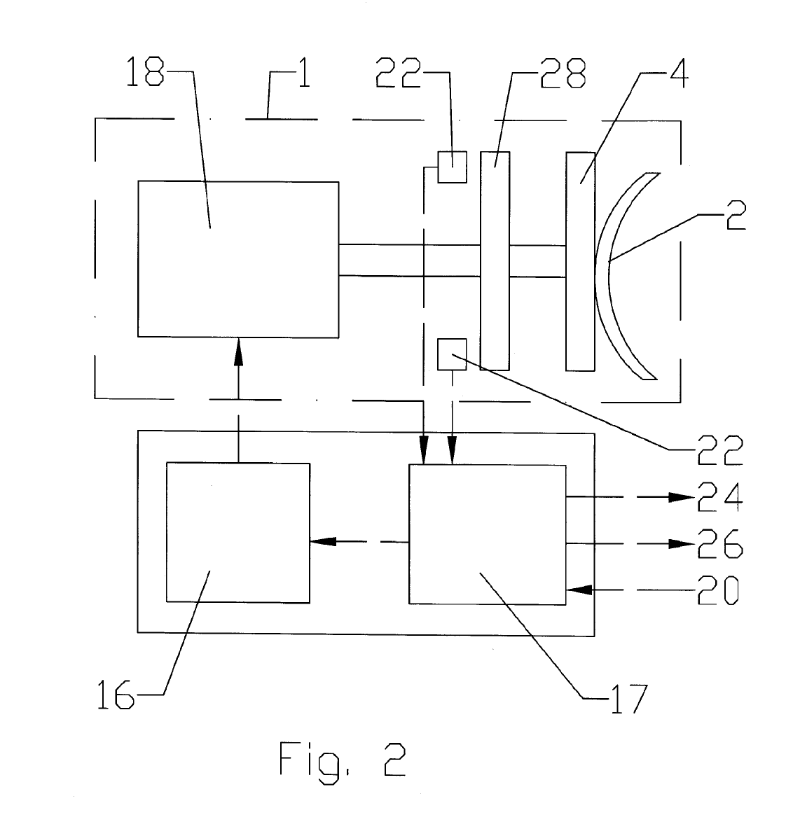

FIG. 2 demonstrates an exemplary motorized subreflector nutation mechanical arrangement 1 and control system 15. The control system 15 may be mounted proximate the nutation mechanical arrangement 1 and typically includes a motor speed control 16 that drives a motor 18 rotating the turntable 4 and thereon the offset mounted subreflector 2 at a known frequency based upon rotational speed command 20 and position sensor 22 inputs received by a current angle and velocity estimator 17 that outputs a current offset angle (e) 24 from which the processors of the supervisory module 32 calculate which quadrant the instant nutation is in. Further, in addition to a motor rotational speed command 20, the current angle and velocity estimator 17 may provide a rotation speed feedback as an additional input to the motor speed control 16.

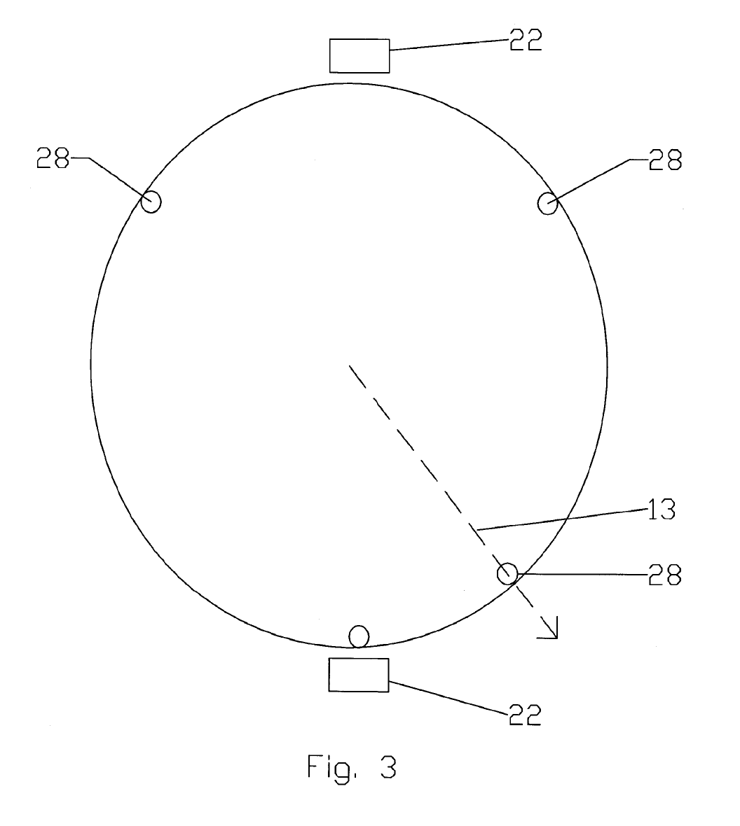

The position sensor(s) 22 may be mounted to sense passage of a target or the like as best shown on FIG. 3. A sync pulse 26, for example provided by a dedicated position sensor 22 reading passage of a dedicated target 28 such as an asymmetrical magnet, may be provided to indicate “top dead center” which is used to restart integration intervals of alignment correction data. The current angle and velocity estimator 17 and motor speed control 16 may be remote mounted in an external enclosure 30 proximate the subreflector 2, with a data message 33 communications link, for example via Ethernet or optical fiber to the supervisory module 32, typically located indoors proximate the tracking receiver 34, signal transceivers and/or related communications and power supply hardware.

FIG. 4 demonstrates an exemplary motorized subreflector processing system. The supervisory module 32 receives the current offset angle 24 and a top dead center sync pulse 26 via the data message 33. A tracking module 38 may be configured to determine a desired nutation rate, output to the as the rotational speed command 20 to the control system 15, select the correct beacon frequency (adjusted as necessary for Doppler) for a tracking receiver 34 receiving a beacon signal 36 from the target signal source. Further, the tracking module 38 may be utilized to set the main dish angles and slew rates to track a rough trajectory of the target signal in concert with subreflector 2 tracking via adjustment of the subreflector 2 x and y axis positioners, as desired.

The data network message(s) 33 may be de-jittered using a, for example, software implemented phase-locked-loop in a nutator model 40, which estimates the current nutation angle 42 output to an accumulator control 44 that feeds into an array of signal accumulator(s) 46 (X+, X−, Y+, Y−) which integrate the nutation angle 42 with a corresponding signal strength 48 from the tracking receiver 34.

The tracking receiver 34 is sampled a number of times per revolution, for example 32 times per revolution, and the samples are integrated selectively based on the quadrant that the present nutation angle 42 is in to create an error vector. Assuming that b[0] through b[32] are the samples, Gₓ and G_{y} are the feedback gains for a simple control loop, and that b[0] is taken at top dead center, the nutated samples give direct errors errorₓ and error_{y} as:

$${error}_{x} = {G}_{x} \frac{1}{32} ( {\sum }_{i = 0}^{15} b [ i ] - {\sum }_{i = 16}^{32} [ b [ i ] ) \\ And \\ {error}_{y} = {G}_{y} \frac{1}{32} ( {\sum }_{i = 0}^{7} b [ i ] - {\sum }_{i = 8}^{23} b [ i ] + {\sum }_{i = 24}^{31} b [ i ] )$$

With the resulting error (x,y) then output as drive instructions 52 from a latch 50 synced by the sync pulse 26 for the respective x and y axis positioner controller(s) 54 of the subreflector 2 carriage and/or main drive.

One skilled in the art will recognize that the present invention represents a significant improvement to prior satellite earth station antenna tracking apparatus, systems and methods. Further, the solution(s) provided are lightweight, compact and low power. Thereby, improved cost, manufacturing, operation and/or maintenance efficiencies may be realized.

Table of Parts

| | |
|---|---|
| 1 | nutation mechanical arrangement |
| 2 | subreflector |
| 4 | turntable |
| 6 | x-axis |
| 8 | y-axis |
| 10 | carriage |
| 11 | motor shaft |
| 12 | circle of rotation |
| 13 | motor shaft longitudinal axis |
| 14 | counter weight |
| 15 | control system |
| 16 | motor speed control |
| 17 | current angle and velocity estimator |
| 18 | motor |
| 20 | rotational speed command |
| 22 | position sensor |
| 24 | current offset angle |
| 26 | sync pulse |
| 28 | target |
| 30 | external enclosure |
| 32 | supervisory module |
| 33 | data message |
| 34 | tracking receiver |
| 36 | beacon signal |
| 38 | tracking module |
| 40 | nutator model |
| 42 | nutation angle |
| 44 | accumulator control |
| 46 | signal integrators |
| 48 | signal strength |
| 50 | latch |
| 52 | drive instruction |
| 54 | drive controller |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A reflector antenna with conical scan subreflector tracking, comprising:
a subreflector coupled to a motor shaft of a motor, the motor coupled to a carriage with an x-axis positioner and a y-axis positioner;
the subreflector positioned, offset from a longitudinal axis of the motor shaft, rotatable via the motor shaft in a circle about the longitudinal axis of the motor.

2. The antenna of claim 1, further including a position sensor configured to detect an angular position of the motor shaft.

3. The antenna of claim 1, wherein the carriage is supported to position the subreflector proximate a focal point of a reflector of the reflector antenna.

4. A reflector antenna subreflector tracking system, comprising:
a subreflector coupled to a motor shaft of a motor, the motor coupled to a carriage with an x-axis and a y-axis positioner;
the subreflector positioned offset from a longitudinal axis of the motor shaft, rotatable via the motor shaft in a circle about the longitudinal axis of the motor;
a position sensor configured to detect an angular position of the motor shaft;
the position sensor coupled to an accumulator;
a beacon receiver outputting a signal strength of a beacon signal received via the subreflector;
a plurality of integrators receiving the angular position of the motor shaft and the signal strength;
the integrators coupled to a latch outputting x and y axis displacement instructions to the x-axis positioner and the y-axis positioner.

5. A reflector antenna having a reflector, a feed and a sub-reflector; the subreflector coupled to a carriage with an x-axis positioner and a y-axis positioner for adjusting the position of said sub-reflector relative to the reflector so as to selectively adjust either or both of a beam elevation and an azimuth of a main beam axis of the reflector antenna;
the carriage positioning the subreflector proximate a focal point of the reflector;
wherein the improvement comprises:
the subreflector coupled to a motor shaft of a motor coupled to the carriage, the subreflector offset from a longitudinal axis of the motor shaft; the subreflector rotatable via the motor.

6. The reflector antenna of claim 4, further including a position sensor configured to detect an angular position of the motor shaft.

7. The reflector antenna of claim 5, further including a beacon receiver receiving a beacon signal from a signal target of the reflector antenna; the angular position of the motor shaft and a corresponding signal strength of the beacon signal usable to generate a signal tracking instruction for the x-axis positioner and the y-axis positioner to guide the main beam axis of the reflector antenna to track the signal target.

8. A method for reflector antenna signal tracking, comprising the steps of:
rotating a motor shaft upon which a subreflector of the reflector antenna is mounted, the subreflector offset from a longitudinal axis of the motor shaft;
monitoring a signal strength received by the reflector antenna as the subreflector rotates around the longitudinal axis of the motor shaft;
generating x-axis and y-axis position instructions based upon a signal strength peak occurring at an angular position of the motor shaft;
actuating an x-axis positioner and a y-axis positioner of a carriage upon which the motor is mounted to move the subreflector with respect to a reflector of the reflector antenna to change a main beam direction of the reflector antenna.

9. The method of claim 7, further including the step of integrating a series of the signal strength received over a range of angular rotation of the motor shaft, each rotation indicated by a sync pulse received from a position sensor of the motor shaft.

10. The method of claim 7, further including the step of monitoring a position of the x-axis and the y-axis positioner and adjusting a main reflector mount if one or both of the x-axis positioner and the y-axis positioner are approaching an end of range of movement; and
adjusting the x-axis and or y-axis positioner which was approaching the end of range of movement proximate a middle of range of movement.
